(19) United States
(12) Patent Application Publication
(10) Pub. No.: US 2019/0213554 A1
(43) Pub. Date: Jul. 11, 2019

(54) USER SUPPORT SYSTEM WITH AUTOMATIC MESSAGE CATEGORIZATION

(71) Applicant: TUPL, Inc., Bellevue, WA (US)

(72) Inventors: Xiang Chen, Bellevue, WA (US); Pablo Tapia, Snoqualmie, WA (US)

(21) Appl. No.: 15/868,950

(22) Filed: Jan. 11, 2018

(51) Int. Cl. G06Q 10/10; G06F 17/30; G06Q 30/00

(52) U.S. Cl. CPC G06Q 10/107; G06Q 30/016; G06F 17/30598

(57) ABSTRACT

Techniques for automatically identifying a user support issue from electronic communications and associating the issue with an appropriate category of user support issue are described. After an issue is identified and assigned to a category, information related to the issue is automatically routed to an entity—such as a person, group, or system —that is trained or otherwise equipped to deal with issues associated with the category. The electronic communications can be emails, texts, voicemails, social media posts, etc. Voicemail communications may be converted to text prior to processing.

### BACKGROUND

A key component of an enterprise's effort to retain users is a functional and efficient user support system. But user support systems can be an expensive undertaking for an enterprise, as such systems usually involve significant investment in capital and human resources. Accordingly, technological advancements that result in lowering resource costs and improving user satisfaction can be very important to the fiscal health of an enterprise.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 is a block diagram of an enterprise employing a user support system that includes a user support monitor.

FIG. 2 is a diagram of an example cellular network environment in which the technological solutions described herein may be implemented.

FIG. 3 is a block diagram of an example computing device utilizing a user support monitor in accordance with the technologies described herein.

FIG. 4 is a flow diagram of an example methodological implementation for training a language model used in a user support monitor.

FIG. 5 is a flow diagram of an example methodological implementation for an operational mode of a user support monitor.

FIG. 6 is a flow diagram 600 that depicts a methodological implementation of at least one aspect of the techniques for using unsupervised learning to validate category identification.

### SUMMARY

Techniques for automatically identifying a user support issue from an electronic communication and classifying the issue within an appropriate category of user support issues are described. After an issue is identified and assigned to a category, information related to the issue is automatically routed to an entity—such as a person, group, or system—that is trained or otherwise equipped to especially deal with issues associated with the category. The electronic communications can be emails, texts, voicemails, social media posts, etc. Voicemail communications may be converted to text prior to processing.

### DETAILED DESCRIPTION

Many enterprises involved in sales or service functions to a large number of customers typically provide user support (i.e., customer support) services so that users/customers that are experiencing issues with a product or service of the enterprise can obtain assistance with a problem. Examples of such enterprises are wide-ranging, and include hotels, airlines, computer companies, telecom companies, automobile companies, and the like. Enterprises incur great expense in staffing user support services and providing technical resources—such as telephones, computer systems, etc.—in support thereof. Many enterprises find financial relief by off-shoring human resource duties to cheaper environs, but that can be a public relations negative for some companies. Finding other ways to reduce expended resources on resolving user issues is important to any enterprise involved in such an operation.

In a typical operation, a user experiencing an issue will contact a user support group of the relevant enterprise by phone, voicemail, email, text message, etc., and explain the issue to a human who is trained to help resolve the issue. The first user support representative to speak to the user will try to help the user resolve the issue but, if after such an attempt is made, no resolution is found, the user support representative may transfer the user to a different representative who may have additional knowledge about the issue.

In many cases, user support services groups are divided in such a way that members of one group are trained in different support topics than are members of a different group. In such cases, the first step in handling a user support issue is to determine which group, or person, a communication reporting an issue should be directed.

This disclosure is directed to techniques that can be implemented to reduce resources necessary to assist a user to find the best opportunity to resolve a user support issue by automatically identifying a category of user issue from the user's initial communication. After a category is determined, information related to the user and/or the issue is forwarded to an entity equipped to deal with the specific category of issue. That entity may be a human, or it may be an automated system designed process information to programmatically derive a possible solution.

In at least one implementation, a user communication that reports an issue is analyzed to determine a category of the issue. The communication can be any type of electronic message, such as an email, a text message, a voice message (after transcription to text), etc. The communication may also be identified from an external site, such as a user forum, a web site, or the like, wherein users tend to post incidents related to user issues they have with products and services. The communication may also be gleaned from a social network site, where a user's comments may be monitored to identify issues the user has with any product or service.

Classic machine learning techniques are applied to estimate, given a particular set of features, a problem instance. Here, the feature set is comprised of a number of key terms, and the problem instance is a category to which an analyzed message belongs. At least one of a number of known classification methods is used with the present techniques to determine the subject matter of a user support message and direct the user support message to an appropriate entity for subsequent processing.

Implementations of the techniques described herein may be used to decrease costs of a user support system by, for example, enabling a smaller group of people to handle user support issues, since the techniques will automatically handle at least one initial step in a user support process. In addition, users will have a more positive experience by having their issues handled immediately by a person or process specially trained to assist with their specific type of issue.

Details regarding the novel techniques reference above are presented herein are described in detail, below, with respect to several figures that identify elements and operations used in systems, devices, methods, computer-readable storage media, etc., that implement the techniques.

### Example Operating Environment

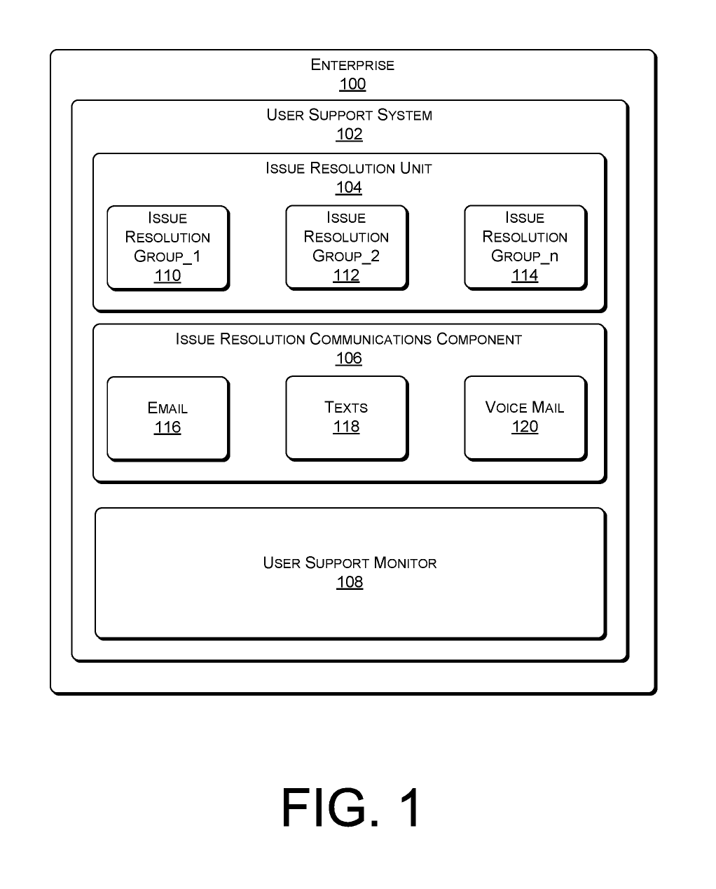

FIG. 1 is a block diagram of an example enterprise 100 that employs a user support system 102 that includes a user support monitor 108. The example enterprise 100 may be any enterprise, such as those listed above, that employ a user support system to manage user issues reported to the enterprise that relate to issues a user experiences with a product or service sold by the example enterprise 100.

The user support system 102 includes an issue resolution unit 104, an issue resolution communications component 106, and a user support monitor 108. The issue resolution unit 104 includes issue resolution group_1 110, issue resolution group_2 112, and so on through issue resolution group_n 114. In an alternative implementation, the issue resolution unit 104 does not include different issue resolution groups, as all components (i.e., representative) in the issue resolution unit 104 may have substantially similar skills and training. The different resolution groups (110, 112, 114) represent components (i.e., representative, systems, software modules, etc.) that are equipped to handle specific categories of user issues.

For example, issue resolution group_1 may be a person, group of persons, software modules, etc. that are able to process technical issues experienced by a user (such as an inability to access an online service), while issue resolution group_2 112 may be a person, group, modules, etc. that are able to process employee service complaints. As a different example, consider an example where the example enterprise 100 is a hotel. Issue resolution group_2 110 may be suited to handle hotel reservation site technical issues, while issue resolution group_2 112 may be suited to handle housekeeping issues.

The issue resolution communications component 106 includes communications subsystems through which user support issues may be received. The subsystems include, but are not limited to, an email system 116, a text message system 118, and a voice mail system 120 which is configured to convert voice messages to text.

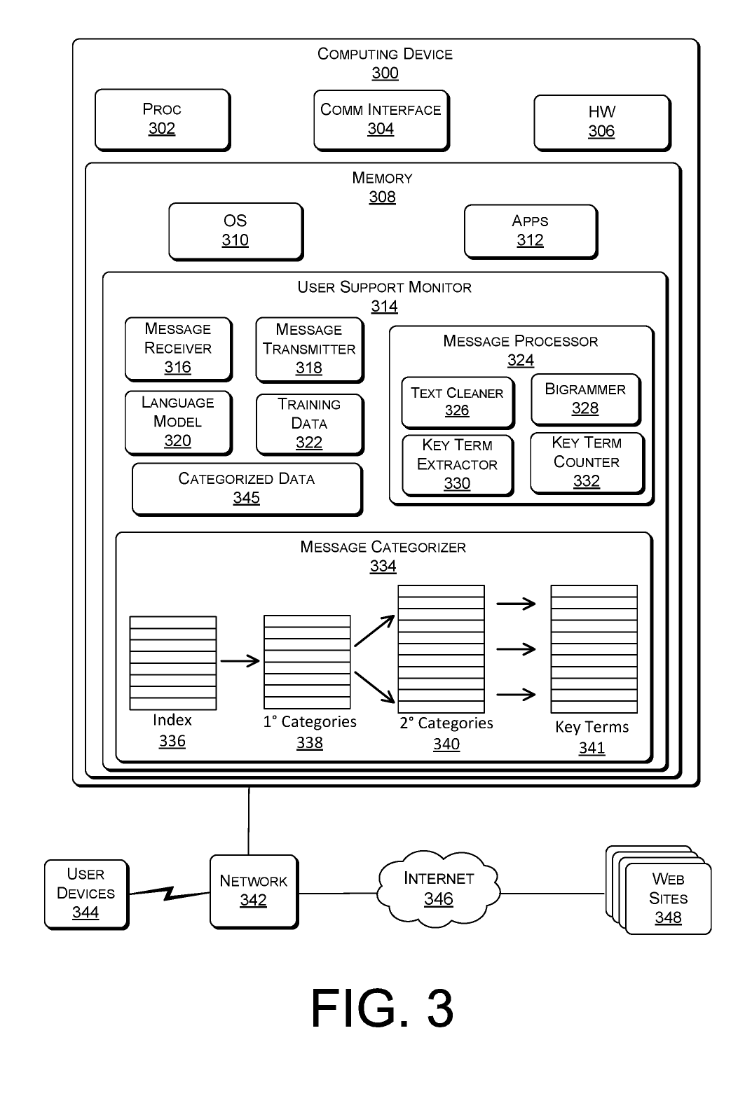

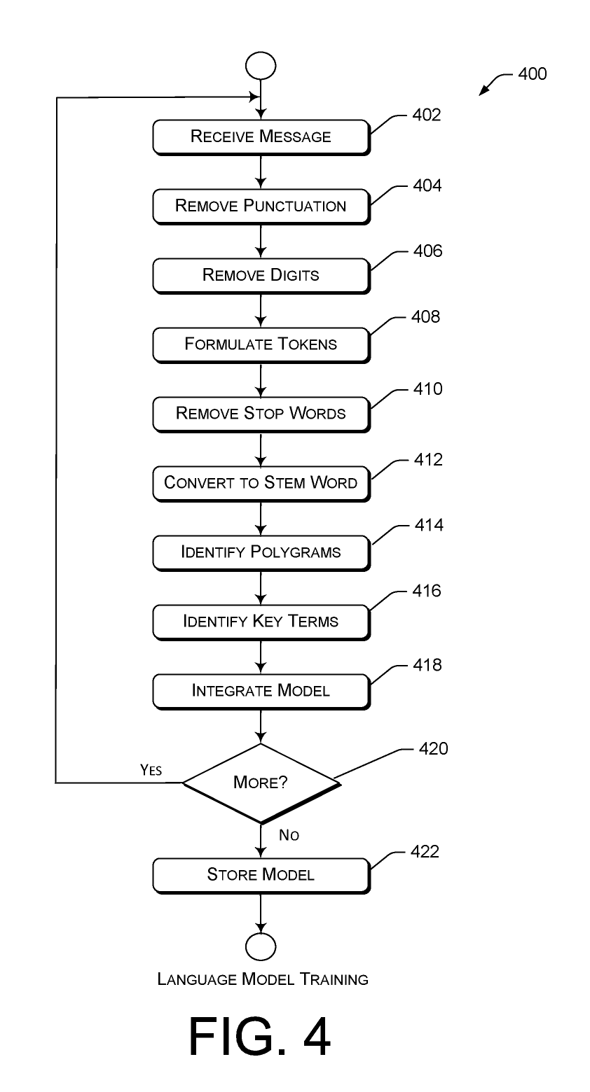

The user support monitor 108 is configured to automatically analyze and categorize messages received by way of the issue resolution communication component 106. The user support monitor 108 is further configured to monitor external messaging sources and automatically identify user support issues appearing therein. The user support monitor 108 is described in greater detail, below, with respect to FIG. 3, and operationally with respect to FIGS. 4-7.

### Example Cellular Network Environment

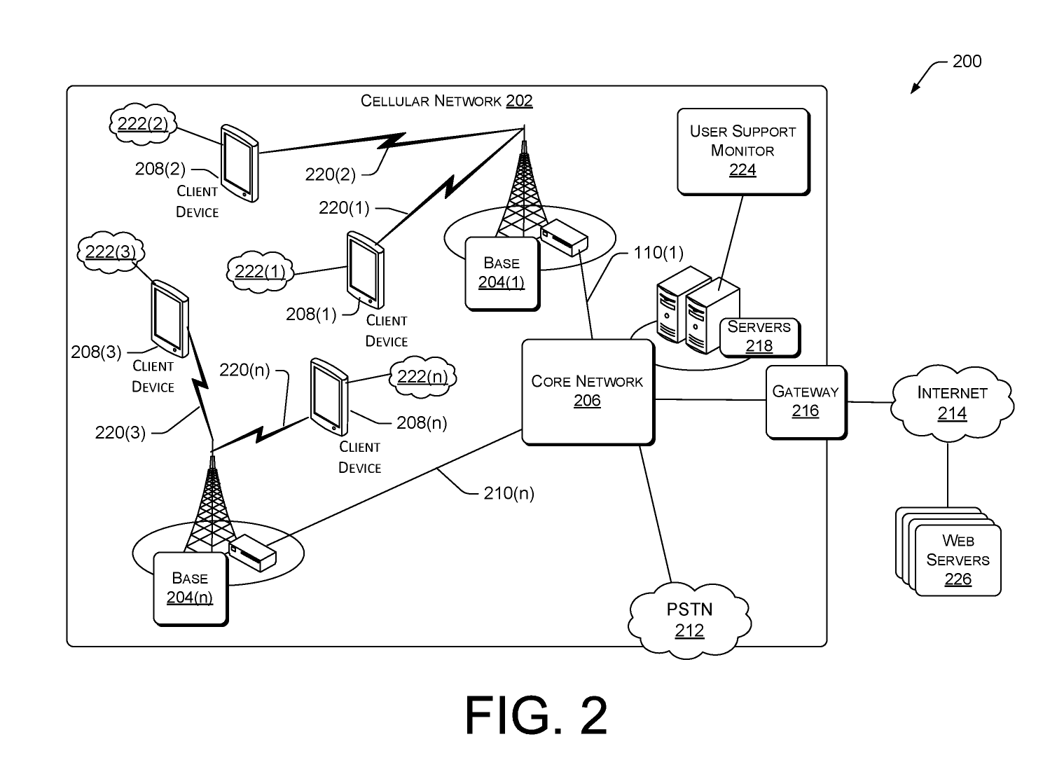

FIG. 2 is a diagram of an example cellular network environment 200 in which the technological solutions described herein may be implemented. Although the present techniques may be implemented within any user support system, FIG. 2 is an example of a specific system within which the techniques described herein may be implemented. Nothing in the following description or in the inclusion of the particular example of a cellular network is intended to limit application of the subject matter defined by the claims appended hereto.

The cellular network environment 200 includes a cellular network 202 that is provided by a wireless telecommunication carrier. The cellular network 202 includes cellular network base stations 204(1)-204(n) and a core network 206. Although only two base stations are shown in this example, the cellular network 202 may comprise any number of base stations. The cellular network 202 provides telecommunication and data communication in accordance with one or more technical standards, such as Enhanced Data Rates for GSM Evolution (EDGE), Wideband Code Division Multiple Access (W-CDMA), HSPA, LTE, LTE-Advanced, CDMA-2000 (Code Division Multiple Access 2000), and/or so forth.

The base stations 204(1)-204(n) are responsible for handling voice and data traffic between client devices, such as client devices 208(1)-208(n), and the core network 206. Each of the base stations 204(1)-204(n) may be communicatively connected to the core network 206 via a corresponding backhaul 210(1)-110(n). Each of the backhauls 210(1)-210(n) are implemented using copper cables, fiber optic cables, microwave radio transceivers, and/or the like.

The core network 206 also provides telecommunication and data communication services to the client devices 208(1)-208(n). In the present example, the core network 206 connects the user devices 208(1)-208(n) to other telecommunication and data communication networks, such as a public switched telephone network (PSTN) 212, and the Internet 214 (via a gateway 216). The core network 206 includes one or more servers 218 that implement network components. For example, the network components (not shown) may include a serving GPRS support node (SGSN) that routes voice calls to and from the PSTN 212, a Gateway GPRS Support Node (GGSN) that handles the routing of data communication between external packet switched networks and the core network 206 via gateway 216. The network components may further include a Packet Data Network (PDN) gateway (PGW) that routes data traffic between the GGSN and the Internet 214.

Each of the client devices 208(1)-208(n) is an electronic communication device, including but not limited to, a smartphone, a tablet computer, an embedded computer system, etc. Any electronic device that is capable of using the wireless communication services that are provided by the cellular network 202 may be communicatively linked to the cellular network 202. For example, a user may use a client device 208 to make voice calls, send and receive text messages, and download content from the Internet 214. A client device 208 is communicatively connected to the core network 206 via base station 204. Accordingly, communication traffic between a client device 208(1)-208(n) and the core network 206 are handled by wireless interfaces 220(1)-220(n) that connect the client devices 208(1)-208(n) to the base stations 204(1)-204(n).

Each of the client devices 208(1)-208(n) are also capable of connecting to an external network, including the Internet, via a wireless network connection other than the cellular network wireless services. As shown, client device 208(1) includes a connection to network 222(1), client device 208(2) includes a connection to network 222(2), client device 208(3) includes a connection to network 222(3), and client device 208(n) includes a connection to network 222(n). The wireless connections are made by way of any method known in the art, such as Bluetooth®, WiFi, Wireless Mesh Network (WMN), etc.

At least one of the servers 218 includes a user support monitor 224, which can be implemented as a software application stored in memory (not shown). Additionally, apart from the cellular network 202, the cellular network environment 200 includes multiple web servers 226 that are accessed through the Internet 214. The web servers 226 host sites and services that can be monitored by the user support monitor 224 for disclosure of user support issues.

### Example Computing Device

FIG. 3 is a block diagram of an example computing device 300 utilizing a user support monitor in accordance with the technologies described herein. The one or more of the servers 218 shown in FIG. 2 are examples of the example computing device 300 in an operating environment, in particular, the cellular network environment 200.

The example computing device 300 includes a processor 302 that includes electronic circuitry that executes instruction code segments by performing basic arithmetic, logical, control, memory, and input/output (I/O) operations specified by the instruction code. The processor 302 can be a product that is commercially available through companies such as Intel® or AMD®, or it can be one that is customized to work with and control and particular system.

The example computing device 300 also includes a communications interface 304 and miscellaneous hardware 306. The communication interface 304 facilitates communication with components located outside the example computing device 300, and provides networking capabilities for the example computing device 300. For example, the example computing device 300, by way of the communications interface 304, may exchange data with other electronic devices (e.g., laptops, computers, other servers, etc.) via one or more networks, such as the Internet 214 (FIG. 2) and web servers 218 (FIG. 2). Communications between the example computing device 300 and other electronic devices may utilize any sort of communication protocol known in the art for sending and receiving data and/or voice communications.

The miscellaneous hardware 306 includes hardware components and associated software and/or or firmware used to carry out device operations. Included in the miscellaneous hardware 306 are one or more user interface hardware components not shown individually—such as a keyboard, a mouse, a display, a microphone, a camera, and/or the like—that support user interaction with the example computing device 300.

The example computing device 300 also includes memory 308 that stores data, executable instructions, modules, components, data structures, etc. The memory 308 is be implemented using computer readable media. Computer-readable media includes at least two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. Computer storage media may also be referred to as “non-transitory” media. Although, in theory, all storage media are transitory, the term “non-transitory” is used to contrast storage media from communication media, and refers to a component that can store computer-executable programs, applications, and instructions, for more than a few seconds. In contrast, communication media may embody computer readable instructions, data structures, program modules, or other data in a modulated data signal, such as a carrier wave, or other transmission mechanism. Communication media may also be referred to as “transitory” media, in which electronic data may only be stored for a brief amount of time, typically under one second.

An operating system 310 is stored in the memory 308 of the example computing device 300. The operating system 300 controls functionality of the processor 302, the communications interface 304, and the miscellaneous hardware 306. Furthermore, the operating system 310 includes components that enable the example computing device 300 to receive and transmit data via various inputs (e.g., user controls, network interfaces, and/or memory devices), as well as process data using the processor 302 to generate output. The operating system 310 can include a presentation component that controls presentation of output (e.g., display the data on an electronic display, store the data in memory, transmit the data to another electronic device, etc.). Additionally, the operating system 310 can include other components that perform various additional functions generally associated with a typical operating system. The memory 310 also stores various software applications 312, or programs, that provide or support functionality for the example computing device 300, or provide a general or specialized device user function that may or may not be related to the example computing device per se.

The memory 308 also stores a user support monitor 314 that is similar to the user support monitor 224 shown stored on the server(s) 218 in FIG. 2. The user support monitor 314 performs and/or controls operations to carry out the techniques presented herein. The user support monitor 314 includes several components that are described immediately below, and further below with respect to the functional flow diagrams shown in FIGS. 4-7.

In the following discussion, certain interactions may be attributed to particular components. It is noted that in at least one alternative implementation not particularly described herein, other component interactions and communications may be provided. The following discussion of FIG. 3 merely represents a subset of all possible implementations. Furthermore, although other implementations may differ, the user support monitor 314 is described as a software application that includes, and has components that include, code segments of processor-executable instructions. As such, certain properties attributed to a particular component in the present description, may be performed by one or more other components in an alternate implementation. An alternate attribution of properties, or functions, within the user support monitor 314, and even the example computing device 300 as a whole, is not intended to limit the scope of the techniques described herein or the claims appended hereto.

The user support monitor 314 includes a message receiver 316 that receives electronic and/or voice messages. In at least one alternate implementation, the message receiver 316 is also be configured to monitor external sources, such as websites or social networks, for messages related to user support. The user support monitor 314 also includes a message transmitter 318 configured to forward a user message to a destination entity. The forwarded user message includes at least a portion of an original user support message received by the message receiver 316, but may also include additional information, such as a category to which the user support message relates, and/or other information that might be useful to the destination entity to resolve an issue identified in the user support message.

The user support monitor 314 also includes a language model 320 that is derived through operations described below, with respect to one or more subsequent figures. The language model 320 is derived from training against a corpus of training data 322, which consists of user support messages similar to user support messages that will be received by the message receiver 216 and analyzed to determine a subject matter for each user support message.

The user support monitor 314 further includes a message processor 324 that is configured to analyze a received user support message and break it down to identify key terms, which are then counted. The message processor 324 includes a text cleaner 326 that is configured to remove punctuation and digits, to convert sentences to sequences of words so that a computer can deal with the user support message at a word level (tokenizer), to remove meaningless words (stop words remover), and to derive a base word for words or terms in the user support message (stemmer, or lemmatizer).

The user support monitor 314 also includes a bigrammer 328. The bigrammer 328 combines multiple adjacent words as a single unit. A combination or words may give different meanings when taken separately than when taken as a whole term. For example, the bigram “not good” has a different meaning than does the single word “good.” The bigrammer 328 analyzes multiple adjacent words to derive the connotation of a multi-word term. Although the word “bigrammer” implies that two words are taken together, it can also apply to more than two words. In such an instance, the bigrammer is more appropriately designated a polygrammer. For convenience and use of a more conventional term, “bigrammer” is used herein to refer to a combination of more than one word.

The user support monitor 314 also includes a key term extractor 330 and a key term counter 332. The key term extractor 330 is configured to extract the most important words and bigrams so that the dimension of the feature set is reduced. In other words, rather than processing each word/bigram contained in a user support message, only the most important terms are processed to create the language model 320. More details on creating the language model 320 are discussed below, with reference to FIG. 4. The most important terms may be determined by how often they appear in the user support message, or by any other known method. The key term counter 332 tracks how many times a key term (word or bigram) appears in a user support message. Implementations vary as to how many key terms are saved, such as the five most common key terms, the ten most common key terms, etc.

The user support monitor 314 also includes a message categorizer 334. The message categorizer 334 includes an index 336, a set of primary categories 338, a set of secondary categories 340, and a set of key terms 341. The index 336 comprises a set of ordinals or other unique identifiers that are associated with each primary category in the set of primary categories 338. Each primary category 338 is associated with one or more secondary category in the set of secondary categories 340. The index 336, the primary categories 338, and the secondary categories 340 are initialized with an implementation. The primary categories 338 and the secondary categories 340 are categories of user support issues typically received by a user support entity. The secondary categories 340 include more granular descriptions of user support issues, and the primary categories 338 include a broader, or less granular, description of user support issues. A secondary category 340 is associated with only one primary category 338. A primary category 338 is associated with one or more secondary categories 340.

As an example, consider a cellular telephone network as shown in FIG. 2. One type of user support issue may relate to “no service,” another user support issue may relate to “weak signal,” and another user support issue may relate to “dropped calls.” All of these types of issues, while related to unique types of issues, are generally related to signal issues. Therefore, secondary categories 340 may include “no service,” “weak signal,” and “dropped calls.” But each of these secondary categories 340 may be associated with a primary category 338 of “signal issues.” Further, there may be a user resolution group that is specially trained to deal with signal issues, so user support messages associated with a category labeled “signal issues” would be directed to that particular user resolution group. In at least one alternate implementation, rather than forwarding issues to a person or group of persons for resolution, the issue may be forwarded to a machine-based component that is configured to perform further processing on the user support message in an attempt to resolve the user support issue.

In at least one implementation, and as described above, the primary categories 338 and the secondary categories 340 are determined by a user and are manually entered into the user support monitor 314. Such an implementation is typically known as “supervised learning,” meaning that user interaction is required. However, in one or more alternate implementations, unsupervised learning may also be used to provide a more accurate set of categories.

After initial categories (primary categories 338 and secondary categories 340) are set up, unsupervised learning clustering methods—e.g., K-means, Gaussian Mixture Models (GMM), and the like—can be applied to determine if one or more additional categories should be added. Such clustering methods can propose clusters based on features without regard to labels.

For example, suppose a case where there are five messages (message 1 through message 5) to which a clustering method is applied. A result could indicate three (3) clusters: Cluster 1 may include message 1 and message 3; Cluster 2 may include message 2; and Cluster 3 may include message 4 and message 5. Even if the meaning of the clusters (i.e., the subject or category of each cluster) cannot be determined, the information may be used to fine-tune category selection.

The results of the unsupervised learning can be compared with the supervised learning results (i.e., the determination of categories), to determine if a discrepancy, or mismatch, exists. Continuing with the example provided above, suppose that there are two primary categories: (1) “No Signal;” and (2) “Dropped Call.” Processing the five messages in the example may result in message 1 and message 3 being placed in the “No Signal” category, while message 2, message 4, and message 5 may be placed in the “Dropped Call” category. But by comparing these results to the results of the unsupervised learning, it is apparent that a new category might be necessary. Particularly, in this example, a new category for message 2 might provide a more accurate system. At this point, a user can interact with the system and create a new primary category 338 or secondary category 340 as required.

Another way that a mismatch may be identified is to compare results from supervised learning with results from unsupervised learning on the same data set. If the unsupervised learning results place messages in different categories than the supervised learning results, a different way of looking at the categories is suggested. Such a result invites further analysis and refinement of the model.

Sometimes, but not always, there is a unique primary category 338 for each unique user resolution group (FIG. 1: 110, 112, 114). However, in at least one alternate implementation, a single user resolution group may be equipped to handle user support issues that fall under more than one unique primary category 338.

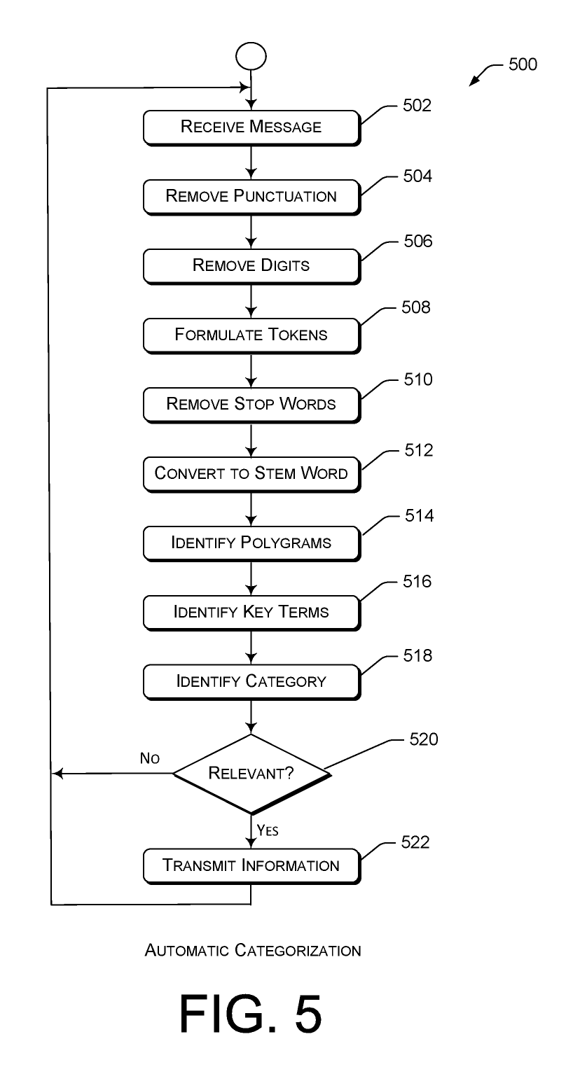

The set of key terms 341 include, for each secondary category 340, a list of one or more key terms (i.e., word or polygram) associated with the category. The set of key terms 341 are derived automatically in a model training operation, which is described below, with respect to FIG. 4. In operation, the key terms are used to compare to key terms identified in a message. If key terms in a message match a significant number of key terms associated with a category, then the message is determined to be associated with the category. Operational aspects of the process are described below, with respect to FIG. 5.

The user support monitor 314 stores categorized data 345 that results from applying the categorization method to a set of data, such as the training data 322. The categorized data 345 indicates which messages, or portions of the data, fall into which categories.

The computing device 300 is configured to communicate with a network 342 that is used by multiple user devices 344 to communicate with the Internet 346 to access multiple web sites 348 (and/or social media sites). The computing device 300 can be configured to receive messages from the multiple user devices 344, to monitor traffic on the network 342 initiated from the multiple user devices 344, or to monitor information posted on one or more of the multiple web sites 348.

Further functionality of the example computing device 300 and its component features is described in greater detail, below, with respect to an example of a methodological implementation of the novel techniques described and claimed herein.

### Example Methodological Implementation—Model Training

FIG. 4 is a flow diagram 400 that depicts a methodological implementation of at least one aspect of the techniques for automatically categorizing user support messages disclosed herein. More particularly, FIG. 4 relates to training a language model for use in one or more techniques described herein. In the language model training operation, a corpus of messages (i.e., the training data, 322, FIG. 3) is processed to derive the key terms 341 that are associated with the secondary categories 340.

In the following discussion of FIG. 4, continuing reference is made to the elements and reference numerals shown in and described with respect to the example computing device 300 of FIG. 3. In the following discussion related to FIG. 4, certain operations may be ascribed to particular system elements shown in previous figures. However, alternative implementations may execute certain operations in conjunction with or wholly within a different element or component of the system(s).

At block 402, a message is received by the message receiver 316 from the training data 322, or corpus. The training data 322 is a set of messages that are similar to messages that are received by a user support system in an enterprise, and may actually be messages that have been previously received by the enterprise. For example, if a target enterprise is a hotel, then the training data 322 is comprised of user support messages received by a hotel enterprise user support system. The training data is in a searchable electronic format, at least a portion of which may be text data that was converted from a voice media format.

Punctuation is not normally considered useful in comprehending for text categorization, so at block 404, the text cleaner 326 removes punctuation from a received message. Likewise, since digits aren't useful to understand in most applications, the text cleaner 326 removes digits from the message at block 406. It is noted, however, that in one or more alternate implementations, punctuation and/or digits may be useful to an understanding necessary to properly categorize messages. In such implementations, the text cleaner 326 can be configured so as not to remove punctuation and/or digits from the message. For the implementations described herein, it is assumed that the punctuation and digits are removed.

Grammatical construct of sentences is not useful in the present operation, so the text cleaner 326 formulates tokens from the sentences in the message (block 408). This results in a string of words that can be analyzed in subsequent operations. At block 410, the text cleaner 326 removes stop words from the message. “Stop words” are meaningless but frequently appearing words that can be removed without consequence to the integrity of the result, such as “the,” “of,” etc. It is noted that this step to remove stop words is optional, and that the analysis may proceed in absence of this step. However, removing stop words reduces the amount of data that is processed in subsequent steps, so such processing is made more efficient by removal of stop words.

The text cleaner 326 converts words into their “stem” word, of “base” word, at block 412. This is typically achieved by use of a stemmer or lemmatizer. As an example, the words “complaints” and “complained” have a similar basic connotation that relates to the base word “complain.” In the presently described techniques, there is no functional difference between “complaints” and “complained,” and their shared base word—“complain”—is used in the described operations.

At block 414, the bigramer 328 identifies polygrams (bigrams, trigrams, etc.) The bigramer 328 combines adjacent words into a single unit when it makes sense to do so. Sometimes, an adjacent word modifies the meaning of a word, such as when the word “not” appears before another word and thus negates the meaning of the other word (e.g., “good” versus “not good”). Similarly, more than two words may be taken as a single term, such as “not as good,” “not so hot,” etc. Also, a modifying word can be used to distinguish between two objects identified by a subject word, as when distinguishing between a “dropped call” and a “short call” (a “short call” meaning that a connection period is too short to be functional, such as when a call is connected, no voice is heard). By combining adjacent words, the bigramer 328 ensures that the proper meaning is identified for subsequent processing.

At block 416, the key terms (i.e., words and polygrams), are identified. More specifically, the key term counter 332 counts the number of times each unique term (word and/or polygram) appears in a message. The key term extractor 330 is configured to calculate the mutual information for each term in the message, and then select the key terms, those being the terms that most frequently occur in the message. In at least one implementation, the key terms are the twenty (20) terms that occur most often in a message, though this number can vary among implementations.

A classic machine learning classification model may be used in the training process. Examples of such learning classification models include Naïve Bayes, softmax regression, random forest, etc. Inputs to the model include features such as key terms, key term counts, and categories (i.e., category text string labels). Overall input is split into two parts, namely: training data set and testing data set. The training data set is used in the actual training of the model with certain hyper-parameters (e.g., number of trees in random forest model). The testing data set is used to select the best model with the optimal hyper-parameters. The best model is selected based on classification accuracy when applying the trained model with the testing data set.

At block 418, the key terms information is integrated into the language model 320, which also includes the index 336, the primary categories 338, and the secondary categories 340. The language model 320 for a particular type of enterprise (e.g., hotel, airline, telecom provider, etc.) is thus created. Once created, a language 320 model may be used in multiple enterprises of the same type.

If there are additional messages to process (“Yes” branch, block 420), then the process reverts to and repeats from block 402. If there are no additional messages to process (“No” branch, block 420), then the language model 320 is stored at block 422 and the process terminates. At the end of the operation described in FIG. 4, a useable language model 320 is complete for use in the automatic categorization process shown and described in relation to FIG. 5, below.

### Example Methodological Implementation—Automatic Categorization

FIG. 5 is a flow diagram 500 that depicts a methodological implementation of at least one aspect of the techniques for automatically categorizing user support messages disclosed herein. In the following discussion of FIG. 5, continuing reference is made to the elements and reference numerals shown in and described with respect to the example computing device 300 of FIG. 3. Furthermore, in the following discussion related to FIG. 5, certain operations may be ascribed to particular system elements shown in previous figures. However, alternative implementations may execute certain operations in conjunction with or wholly within a different element or component of the system(s).

The first number of operations shown in FIG. 5 are similar to respective operations shown in FIG. 4, since similar operations are performed in training as well as in operation. Therefore, the redundant operations (block 502 through block 516) will only be described briefly, below.

At block 502, a message is received from the message receiver 316. The message may be received directly from a user—as when a user sends an email to a user support division of an enterprise—or it may be received after it is detected from monitoring a web site or social media account. The text cleaner 326 removes punctuation (block 504) and digits (block 506), and tokenizes the sentences in the message (block 508). The text cleaner 326 then removes stop words at block 510 and converts words (and/or terms) to stem words at block 512. At block 514, the key term extractor 330 works in conjunction with the key term counter 332 to identify key terms that occur in the message.

At block 518, an attempt is made to identify a category to which the message belongs by comparing the key terms identified in block 516 to the key terms 341 that are associated with secondary categories 340 (and, by reference, to primary categories 338). If there is not a sufficient match, i.e., the key terms are not relevant to categories (“No” branch, block 520), then the process reverts to block 502 without further action. If there is a sufficient match between key terms identified in the message and the set of key terms 341 (“Yes” branch, block 520), then information is transmitted by the message transmitter 318 at block 522.

The message transmitter 318 is configured to identify a destination to receive the user support message for a particular category. For example, a first category may relate to service issues, and a second category may relate to equipment issues. It may be desirable that messages in each of these categories go to different destinations. Therefore, the message transmitter 318 transmits messages related to service issues to a first destination, and messages related to equipment issues to a second destination. The destination may be a particular person, a particular sub-group within a user support group, or a machine-based component that is configured to process messages in a particular category in a certain way. The process then repeats from block 502.

Example Methodological Implementation—Unsupervised Learning

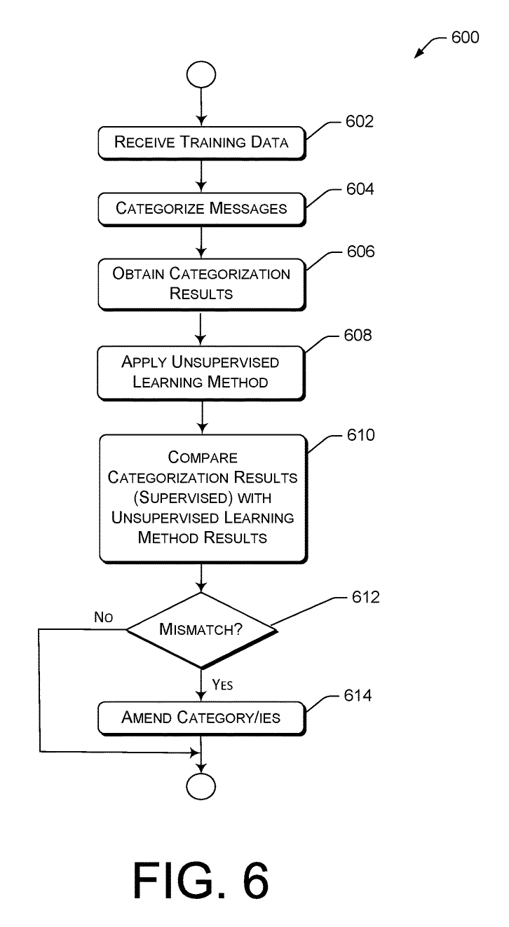

FIG. 6 is a flow diagram 600 that depicts a methodological implementation of at least one aspect of the techniques for using unsupervised learning to validate category identification. In the following discussion of FIG. 6, continuing reference is made to the elements and reference numerals shown in and described with respect to the example computing device 300 of FIG. 3. It is noted that in the following discussion related to FIG. 6, certain operations may be ascribed to particular system elements shown in previous figures. However, alternative implementations may execute certain operations in conjunction with or wholly within a different element or component of the system(s).

At block 602, training data 322 is received by the user support monitor 314. The training data 322 is processed by the message categorizer 334 at block 604 and, as a result, messages included in the training data 322 are sorted into primary categories 338 and secondary categories 340 and the results are stored as categorized data 345 at block 606.

At block 608, an unsupervised learning clustering method is applied to the training data 322. Any clustering method may be used for this purpose, including, but not limited to K-means, Gaussian Mixture Models (GMM), etc. The results from the clustering method application are compared with the categorized data 322 at block 610. If the clustering method indicates that there is a number of clusters equal to the number of categories or that unsupervised learning clusters messages the same as supervised learning, then there is not a mismatch and no further processing is required (“No” branch, block 612).

If, however, there is a mismatch (“Yes” branch, block 612), (e.g., there is a discrepancy between the results of the clustering method and a number of categories in the categorized data 322, or the unsupervised results are different from supervised results after processing the same data) then this suggests that one or more additional categories may be desired or that a restructuring of categories may be needed. Analysis of the results may lead to the addition of one or more new categories or a restructuring of categories at block 614.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
receiving a user support message that identifies an issue related to a system having one or more users;
analyzing the user support message to automatically identify the issue;
automatically identifying a category related to the issue; and
forwarding information related to the issue to an appropriate entity for resolution of the issue based on the identified category.

2. The method as recited in claim 1, wherein the analyzing further comprises comparing terms in the user support message to terms derived from training using multiple user support messages.

3. The method as recited in claim 1, wherein the forwarding further comprises sending the information to a person designated to provide support for issues related to the category.

4. The method as recited in claim 1, wherein the forwarding further comprises sending the information to a system component configured to provide support for issues related to the category.

5. The method as recited in claim 1, wherein:
the automatically identifying a category further comprises automatically identifying a secondary category related to the issue; and
the method further comprises automatically identifying a primary category that includes the secondary category, the primary category including one or more secondary categories.

6. The method as recited in claim 1, wherein the receiving a user support message further comprises monitoring communications to identify a user support message.

7. The method as recited in claim 1, wherein the receiving a user support messages further comprises:
receiving a voice message; and
converting the voice message to text.

8. A system, comprising:
a message receiver configured to receive a user support message;
a message processor configured to analyze a user support message and identify key terms in the user support message, the key terms relating to a user support issue;
a message categorizer configured to identify a category for the user support message from the key terms; and
a forwarding component configured to forward information related to the message to a subsequent entity, the subsequent entity being associated with the identified category.

9. The system as recited in claim 8, wherein the message receiver is further configured to monitor electronic messages to identify the user support message.

10. The system as recited in claim 8, wherein the message receiver is further configured to monitor messages on one or more social media sites to identify the user support message.

11. The system as recited in claim 8, further comprising a category table that includes one or more primary category names and one or more secondary category names, wherein each primary category name is associated with one or more secondary category names, and each secondary category name is associated with a primary category name.

12. The system as recited in claim 8, wherein the forwarding component is further configured to forward information related to the message to a personnel group associated with the identified category.

13. The system as recited in claim 8, wherein the messaging component is further configured to forward information related to the message to a processing module associated with the identified category.

14. The system as recited in claim 8, further comprising a voice-to-text convertor configured to convert a voice message to a text message that comprises the user support message.

15. One or more computer-readable storage media including computer-executable instructions that, when executed by a computer, perform the following operations:
receiving an electronic communication that identifies a user issue related to a system having multiple users;
analyzing the electronic communication to automatically identify the user issue;
automatically identifying a category related to the user issue; and
transmitting information related to the issue to one of multiple entities equipped to resolve the user issue based on the identified category.

16. The one or more computer-readable storage media as recited in claim 15, wherein:
the analyzing further comprises identifying at least one key term in the electronic communication;
the automatically identifying a category related to the user issue further comprises locating the at least one key term in a category lookup table; and
the transmitting information related to the issue further comprises transmitting at least a primary category label associated with the at least one key term in the category lookup table.

17. The one or more computer-readable storage media as recited in claim 15, wherein the transmitting information related to the issue further comprises transmitting information related to the issue to a person designated to provide user support for issues related to the identified category.

18. The one or more computer-readable storage media as recited in claim 15 wherein the transmitting information related to the issue further comprises transmitting information related to the issue to a system configured to provide automated support for issues related to the identified category.

19. The one or more computer-readable storage media as recited in claim 15, wherein the one or more computer-readable storage media further comprises additional computer-executable instructions that, when executed, performs an operation of automatically identifying a label associated with the issue; and
wherein automatically identifying a category related to the user issue further comprises identifying a category associated with the label, wherein the category is associated with one or more labels.

20. The one or more computer-readable storage media as recited in claim 15, wherein the receiving an electronic communication further comprises monitoring multiple electronic communications to identify the user issue.
